(19) United States
(12) Patent Application Publication
(10) Pub. No.: US 2010/0128990 A1
(43) Pub. Date: May 27, 2010

(54) METHOD FOR MEASURING/RECOGNIZING A SHAPE

(76) Inventor: Kari Seppälä, Helsinki (FI)

Correspondence Address: FAY SHARPE LLP, 1228 Euclid Avenue, 5th Floor, The Halle Building, Cleveland, OH, 44115, US

(21) Appl. No.: 12/295,897

(22) PCT Filed: Apr. 5, 2007
(86) PCT No.: PCT/FI2007/000085

§ 371 Date: Feb. 9, 2010

(30) Foreign Application Priority Data
Apr. 5, 2006 (FI) 20060331

(51) Int. Cl. G06K 9/46

(52) U.S. Cl. 382/203

(57) ABSTRACT

A method for measuring/recognizing a shape uses at least two electromagnetic oscillations aimed at the measurement subject from two different directions. A device is provided for taking an image of the illuminated subject in a digital form. The image matrix of the image in a digital form is read pixel by pixel and the illuminated strength values of the same pixel from different directions are compared with each other. The difference of the strength values of the two wavelengths of each pixel is added to the corresponding difference of the preceding pixel in the reading direction.

The present invention relates to a method for measuring or recognizing a shape.

The measurement of a surface is required in many different applications of technology. Examples of such applications are the measurement of particle size, for example, in various pharmaceutical quality-control applications. On the other hand, measurement of the shape of a surface is also used in various kinds of pattern recognition, from the simple recognition of a shape to the recognition of the face of a person, or as far as the recognition of even more complex patterns.

Some examples of applications of the prior art in the general area of the invention are given in the following publications.

The publications FI 20000493, U.S. Pat. No. 5,239,358, JP 10010033, U.S. Pat. No. 6,122,043, and WO 03062804 disclose the optical measurement of the particle size or surface shape of a powder. In the publication Laitinen, Antikainen, Yliruusi, Does a powder surface contain all necessary information for particle size distribution analysis?, European Journal of Pharmaceutical Sciences, 17(4-5), 217-227, there is a description of a measuring device, in which two sources of white light are used and the sample is imaged using a single camera. In the said publication, the measuring device described takes two separate black-and-white photographs. The first image is taken with a first lamp illuminating the subject and the second image is taken with a second lamp illuminating the subject. The so-called difference-matrix distribution is calculated from these two images.

An example of a drawback of the method described above is that, as two separate photographs are taken, which are illuminated alternately, particle size cannot be measured from a moving subject.

The following list also refers to publications, which disclose various measurement methods and improvements to them: U.S. Pat. No. 6,556,706, WO 02059545, U.S. Pat. Nos. 6,028,672, 6,974,964, and DE 19962779.

The present invention is intended to create a method and apparatus, with the aid of which the measurement and recognition of the shape of a surface can be performed rapidly with great precision, even from a moving subject. This provides enormous opportunities to exploit the invention is very many different areas of technology.

The aforementioned and other benefits and advantages of the present invention are achieved in the manner described as characteristic in the accompanying Claims.

In the following, the invention is examined with reference to the accompanying drawings, which some schematic embodiments of the invention.

Thus:

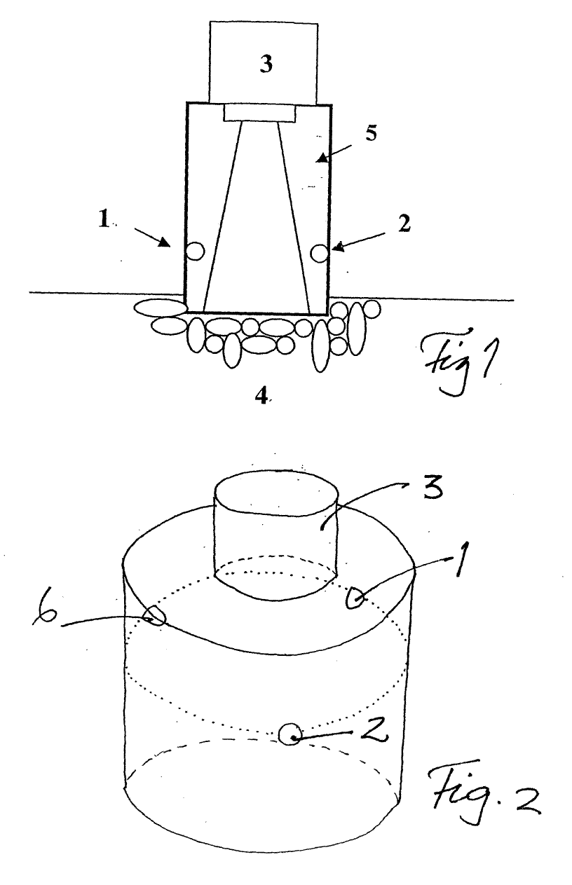

FIG. 1 shows a simplified schematic image of one embodiment according to the invention;

FIG. 2 shows a second schematic measurement geometry;

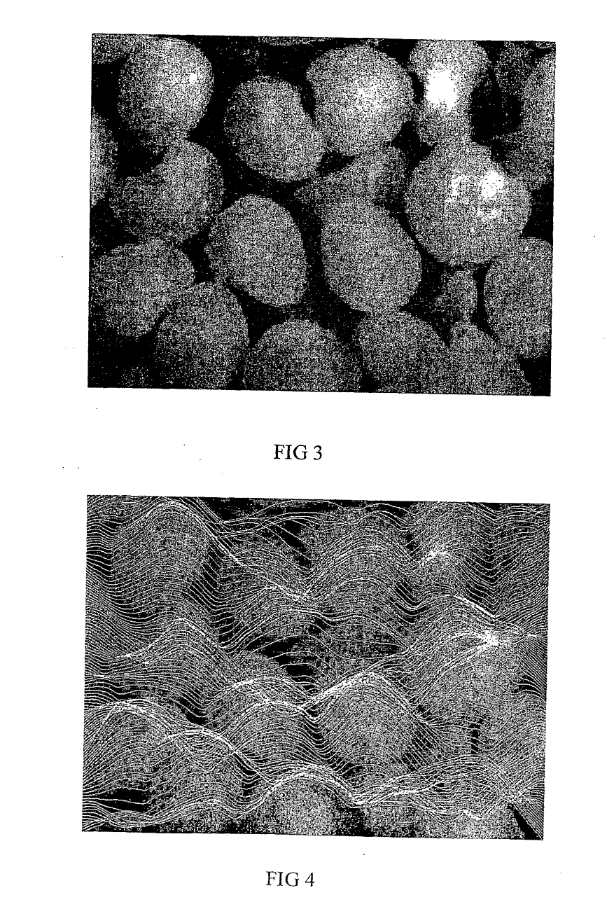

FIG. 3 shows an image of a surface, obtained using the method and test apparatus according to the invention;

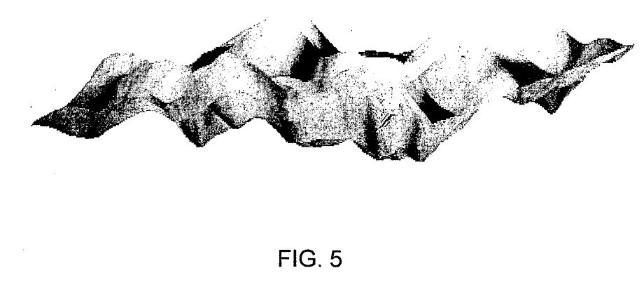

FIG. 4 shows the image according to FIG. 3, including contours calculated by the method, in the stage of producing the result;

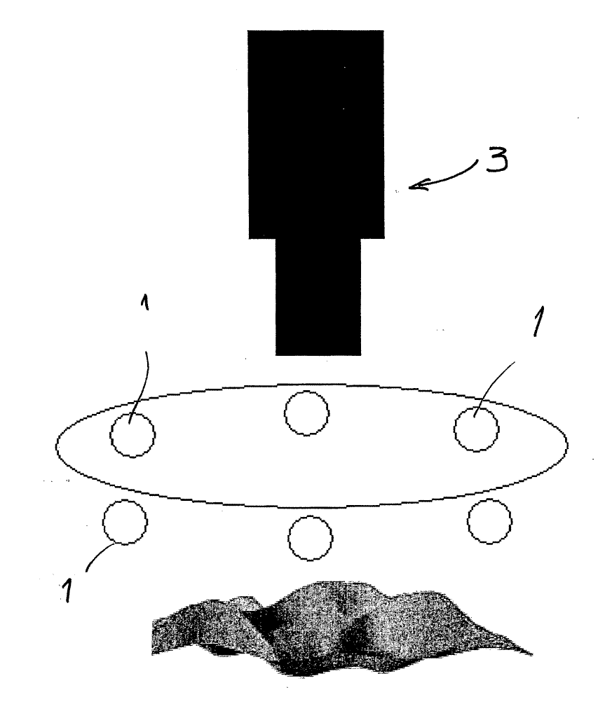

FIG. 5 shows a topographic image produced by the system; and

FIG. 6 shows another kind of arrangement for exploiting the invention.

As stated above. FIG. 1 shows one example of an arrangement, with the aid of which tests have been performed in order to examine the system. Thus, the surface-shape measuring device, which is the subject of the invention, and which is used in this arrangement, includes two differently coloured light sources, for example, a red 1 and a blue 2 source, as well as a camera 3. The digital camera 3 takes two images, a red and a blue, simultaneously of the subject 4 being examined. The camera images the subject from above and the light sources 1 and 2 are on opposite sides of the sample and aimed at the sample 4 at an angle of about 45°.

As stated, this arrangement has been made only for experimental observations, and does it necessary have anything to do with actual practical applications. FIG. 2 shows another example of a measuring arrangement, which illustrates the situation when operating with three differently coloured measuring lights, for example, a red, a blue, and a green light. The precision of the measuring device increases considerably in a system with three lights.

All conventional connection technology has been omitted from the figures. It is, of course, obvious that, for its image processing, the camera is connected to a computer device, in which there is a suitable program for performing the necessary calculation tasks, on the basis of which the desired end result is achieved.

The illuminating power of the red, blue, and green colour of each pixel (image-element) is recorded in a digital image. The relative surface height is calculated from the digital image by a simple subtraction calculation of the strength values of the different part colours of the pixel. The pixels are read consecutively in the direction of the light-source pair.

A three-light system is illustrated in FIG. 2, in which the measuring structure is depicted by a cylinder, at the assumed bottom of which is the surface being measured, which in practice can naturally be any surface whatever. A red light source 1, a blue light source 2, and a green light source 6 are located on the wall of the cylinder 5. In this construction, the image can be read in three different directions and the height of the particle can be measured from different sides of the particle. Nothing prevents the lights from also being placed in an asymmetrical configuration relative to the sample, in both the vertical and horizontal directions.

The measurement according to the invention is performed more specifically as follows. Each pixel is read, as stated above, in consecutive order in the direction of each pair formed of two lights. It is assumed that the reading is performed relative to two lights, for example a blue and a green, which light illuminate the subject from two different directions. The reading is performed pixel by pixel over the subject being measured. The intensities of the green and blue lights are measured at the said pixel. If the surface is flat at the point being read, the intensity of both the green and the blue lights will be the same. The difference in the light intensities, which in this case is zero, is calculated.

Next the intensities of the colours of the following pixel are read and a subtraction calculation is performed. Any difference that arises forms a base for the next pixel. Thus the base formed by the difference of the previous pixel is added to the difference in intensity of the colours of the next pixel, i.e. a cumulative addition is performed.

Always performing the comparison in the same direction has the consequence that if the shape of the surface is rising, the cumulative sum increases while a falling surface shape causes a reduction in the cumulative sum. If the difference in intensities is calculated in the other direction, all that changes is that arising surface shape will cause a negative direction in the cumulative value and a falling surface shape a positive direction.

Performing the reading of the area being examined pixel by pixel results in a very precise image of the shape of the surface.

FIG. 3 shows a photograph-like presentation of a surface imaged using the arrangement according to the invention. FIG. 4 shows the aforementioned surface equipped with lines, which depicted the result when forming the path of the read lines on the surface.

FIG. 5 shows, for its part, a topographical image of the end result obtained. These figures, and particularly FIG. 5 show the great practical value of the arrangement according to the invention.

The measuring sensor can be attached permanently to the process, or else the measuring sensor can be like an endoscope in the moving subject, which can be, for example, a granular, mixed, crystallized, or suitably static granular mass. In a more highly developed form, the basic idea of the invention can be used for any pattern recognition whatever. This can mean, for instance, face recognition in security checks or other such applications.

Imaging the subject requires only a single exposure is required, which allows a moving subject to be imaged, because all the information coming to the image to be analysed is obtained simultaneously. Naturally, the measurement does not damage the sample.

The scope of application of the invention is very wide. It can be assumed that various measurement tasks in the pharmaceutical industry form quite a large area of application. Measurement is required in raw-material manufacture and quality control, as well as in the final manufacture of the actual pharmaceuticals. The foodstuffs industry, like the pharmaceutical industry, is a large user group. Examples of other industrial sectors with a need to use the method and apparatus according to the invention include the paper industry, the paint industry, while more broadly nearly all parts of the chemical industry require surface or shape recognition.

Considered further, the invention is also suitable for use in the electronics industry, the building industry, or the engineering industry in general. In an even more highly developed form that invention can be applied and used in various security checks, as already referred to above, for example, in frontier surveillance.

The method according to the invention can be used very successfully, for example, for measuring particle size. A drawback of measuring devices presently in use is a poor recognition sensitivity to particles that are in a large mass, as present methods cannot reliably distinguish outlines, on the recognition of which they are based. According to the present invention, three points on the surface of the particle, for example, are defined, from which the size of the particle is calculated by assuming it to be round. Though this assumption is in no way necessarily correct, practical experiments have given very accurate particle-size definitions as a result of it.

The method can be used to rapidly measure and examine the roughness of various surfaces. Roughness is important in several areas. Examples of applications are the surface of paper, painted wooden surfaces, and metal and plastic surfaces that are machined in various ways.

The method can be used to examine the straightness of a surface, how straight some surface is relative to a measurement subject.

Quality inspection too, for instance when painting, galvanizing, etc., forms part of the examinations that can be easily implemented by means of the method according to the invention.

Fingerprint recognition can be easily implemented using the method of the invention.

Pattern recognition can be performed quickly. For example, in access control codes are not required, the door opening one the system reads the 3D co-ordinates of the face of someone approaching, which are recorded in the system, and which, due to the third dimension, can be considerably simpler and more detailed compared to 2D recognition. In addition, by way of example: a computer can start, a mobile phone can switch on, a car door can open, if an image is taken and the user identified with its aid.

Other examples include the examination of the structure of the skin. For example, in the skin-cream industry an easy method is required for measuring the number/type of wrinkles without irritating the skin.

The inspection of the quality of building materials during construction and the investigation of the durability of materials in long-term tests. The building materials can be, for example, timber, brick, concrete, steel.

The monitoring of the dissolving of a surface. Possible examples are the real-time dissolving of a crystal or a tablet containing a pharmaceutical agent. In such cases what is investigated is how the structure of the surface changes during dissolving.

The real-time monitoring of crystal growth. In crystal growth, it is often wished to see how an individual crystal grows. The method provides a rapid method for monitoring the growth of a crystal, which does not destroy the subject.

Monitoring of surface contamination. In many situations it is necessary to monitor the contamination of surfaces (wall surfaces, floors, research and manufacturing devices).

Microscope applications. A rapid 3D image can be created using a conventional microscope.

Endoscope applications. The method can be used in connection with an endoscope, in which case all the areas of application of an endoscope are involved.

Digital camera. An option according to the method can be easily built into a digital camera.

Mobile telephone/trend games. An option according to the invention can be easily built into the camera of a mobile phone. The phone will recognise the user and switch. Garners can create, for example, game characters for role games, which have the player's own 3D face.

Monitoring of the quality of a road surface, and the exploitation of the measurement in question, for example, in anti-skid systems.

Monitoring of an airport runway surface during aircraft landing.

Other tuning methods: for example, the use of ultrasound. 3D imaging of foetuses using ultrasound, medical imaging, for example, cancer diagnosis.

Echo-sounding applications is various mediums: by using two ultrasound sources, the method can be used to define 3D structures, as it can by using electromagnetic radiation too. The method can be utilized, for example, in water, as in echo-sounding applications used at sea.

The method according to the invention can also be used to investigate, for example, metal structures or soil.

Above, reference has only be made to lights of a specific colour, which are used according to the invention. This is certainly not the whole truth, as according to the invention it is possible to use two or more sources of any electromagnetic radiation whatever. The essential factor is that the result that arises is a combination of two or more data appearing in a manner that can be distinguished from each other, the difference between which can be read and altered according to the principles presented above.

One example of another kind of arrangement for the application of the invention is shown in FIG. 6. In the figure, the camera is marked with the reference number 3 and the light sources, of which there are six in the figure, are marked with the reference number 1. There can be a desired number of light source, which can be of a clearly greater number than six. Below is also an outline of the shape of the recognized surface.

In the case described above, it is possible to proceed in several different ways. For example, each light source can be used in turn to take an image of the subject and the images taken from two directions can be compared with each other. Thus it is possible to operate, if desired, using only a single type of light, for instance white light. On the other hand, it is possible to use two different lights in pairs. By way of example, it is possible to use a blue and green pair of lights, which illuminate the subject from different directions and perform the further operations as described above. It is also possible to illuminate the subject in such a way that, for instance, six different wavelength ranges are filtered from the electromagnetic spectrum (three different illumination pairs). These illumination pairs are placed symmetrically, according to FIG. 6. Proceeding in this way—as also when there are suitable filters in the receiving cameras—image information collected by a single imaging will be obtained. By using several light pairs, the image will become very precise.

Electromagnetic oscillation can be led directly to the desired subject, or the aid of mirrors, or prisms, or similar means can be used. The electromagnetic radiation can also be manipulated in many different ways, for example, it is possible to use filters in order to amplify specific wavelengths, or to separate or eliminate them. Such ways are known in many areas of technology.

The method according to the invention is very rapid compared to many systems presently in use. The calculating power required to calculate the result and the three-dimensional image on the basis of the image obtained is very reasonable, for which reason the result is obtained very quickly while the variations of the subjects to be measured/recognized are very diverse, because when using the method according to the invention there is no need for calculation processes lasting minutes, or even tens of minutes.

1. Method for measuring/recognizing a shape, using at least two electromagnetic oscillations (1, 2) aimed at the measurement subject from two different directions, and means (3) for taking an image of the illuminated subject (4) in a digital form, characterized in that the image matrix of the image in a digital form is read pixel by pixel and the strength values of the electromagnetic oscillations coming from two different directions are compared with each other, and the difference of the strength values of the two wavelengths of each pixel is added to the corresponding difference of the preceding pixel in the reading direction.

2. Method according to claim 1, characterized in that the wavelengths of the electromagnetic radiations coming in two different directions are essentially identical.

3. Method according to claim 1, characterized in that the wavelengths of the electromagnetic radiations coming in two different directions are different.

4. Method according to claim 1, characterized in that the reading of the image matrix of the image in a digital form is performed one pixel at a time in the direction of the light-source pair.

5. Method according to claim 1, characterized in that the rising, falling, or flat shape of the surface is decided from the difference between the strength values.

6. Method according to claim 1, characterized in that at least two wavelengths of visible light are used in the imaging of the subject being defined.

7. Method according to claim 1, characterized in that a combination of at least two lights from the group, red, blue, and green is used in the imaging of the subject being defined.

8. Method according to claim 1, characterized in that a so-called digital camera, by means of which red, blue, and green images of the subject are taken simultaneously, is used in the imaging of the subject being defined.

9. Method according to claim 8, characterized in that separate electromagnetic oscillation illuminating in the direction of the camera is also used in order to take a total image of the subject.

10. Method according to claim 9, characterized in that the total image is used as an aid when forming a programmatic 3D image of the subject.

11. Use of a method according to claim 1, characterized for determining particle size, characterized in that at least three pixel locations are determined from the surface of the particle, and the size of the particle is approximated from them.

12. Method according to claim 1, characterized in that mirrors, prisms, filters, polarizers, and similar means are used in it, in order to affect the electromagnetic radiation.
